(19) United States
(12) Patent Application Publication
(10) Pub. No.: US 2004/0245673 A1
(43) Pub. Date: Dec. 9, 2004

(54) Wear components in powder coating system

(76) Inventor: Robert J. Allsop, South Amherst, OH (US)

Correspondence Address: CALFEE, HALTER & GRISWOLD, LLP, 800 SUPERIOR AVENUE, SUITE 1400, CLEVELAND, OH, 44114, US

(21) Appl. No.: 10/754,245

(22) Filed: Jan. 9, 2004

Related U.S. Application Data
(60) Provisional application No. 60/320,256, filed on Jun. 9, 2003.

(51) Int. Cl. B29C 45/16; B05C 5/00

(52) U.S. Cl. 264/259; 264/255; 264/139; 118/308

(57) ABSTRACT

Wear components of a powder coating system are provided with a coded visual element in one aspect of the invention. The coded visual element can provide an indication of the manufacturer or a characteristic of the part. In molded parts, the coded visual element can be implemented as a different color overmolded part wherein a material of one color is overmolded on a base material of another color. The overmolded material can be elastomeric and formed with integral exterior rings to provide a friction fit for the wear component in, for example, a venturi pump or a spray gun while eliminating the need for separate O-rings and the need to machine or form grooves in the exterior of the parts to receive the O-rings. Similarly, integral flanges can be formed to eliminate the need for separate snap rings and grooves to accept the snap rings. Color coding of the overmolded material can also be implemented in a way to provide an indication of wear. Alternatively, the part can be constructed as a layered structure of two or more materials to provide an indication of wear with or without a visual coding element Another aspect of the invention is the idea of forming the replacement part as a single piece part such as a molded part. This type of part can be formed to incorporate integrally formed resilient rings and/or integrally formed flanges on the exterior of the part to take the place of O-rings and snap rings.

### RELATED APPLICATION

This application claims the benefit of U.S. Provisional Application No. 60/320,256, filed Jun. 9, 2003.

### BACKGROUND OF THE INVENTION

The present invention relates to powder coating systems and, in particular, to powder coating systems that include replaceable wear parts.

Powder coating of products is a known technique involving the spraying of powder coating material, having an electrostatic charge, on a workpiece that is electrically grounded. The powder coating material is attracted to and adheres to the workpiece to coat the workpiece. The coating material is then fixed to the workpiece by heating.

The powder coating material to be sprayed is drawn from a powder supply line by a venturi pump. In the pump the material mixes with a stream of rapidly flowing air. This mixing takes place within a venturi throat, which is a tubular plastic piece removably inserted in a throat holder in the pump. The mixture of air with entrained powder flows through a hose to a spray gun. The hose is connected to the gun by a hose connector. The powder material exits the gun through a spray nozzle.

The flow of powder through the throat wears away the plastic material of the throat, and so the throat is designated as a wear part of the system, that is, a part that is periodically removed and replaced when worn beyond a certain amount.

In some powder coating systems, different size throats can be provided. For example, in one known system, a “standard flow” throat and a “low flow” throat can alternatively be inserted in the throat holder of the pump. The two throats are identical on their outsides, and vary only in their inner diameters. Thus, it is necessary to use a plug gage or a visual inspection of the inner diameter to ensure that the correct throat is replaced. This process can be time-consuming and inefficient.

The venturi throat of the powder pump is just one example of a wear part in a powder coating system. The spray nozzle of the powder coating gun and the hose connector which connects the hose to the gun are two other examples of wear parts in a powder coating system. Wear parts are components that are contacted by the powder coating material as the powder coating material flows through the parts. The flow of powder coating material through a wear part wears away the material of the part where the contact is made, creating the need to periodically replace the part.

When parts are replaced, it would be useful to know if they were replaced with parts manufactured by the original manufacturer or parts manufactured by a third party. Often times only trained service personnel can determine the difference. This determination can affect warranty coverage for the parts and can provide useful information in troubleshooting any problems which are being experienced with the system.

Another problem with replacement parts is that it is sometimes difficult to determine by a visual inspection whether a part is sufficiently worn to be replaced.

Wear parts of the system are typically friction fitted for ease of disassembly, cleaning and replacement without the need for tools. For example, the spray gun nozzle is a machined plastic tubular member having two external O-rings. The O-rings seal and provide a friction fit for the nozzle in the gun body. Similarly, the venturi pump throat is a machined plastic part having two external O-rings that provide a friction fit for the throat in the throat holder. In addition, the throat has an external snap ring that provides a shoulder for locating the throat longitudinally in the throat holder, that is, limiting its inward movement during insertion. Forming these parts as multiple piece assemblies increases the fabrication costs and complicates replacing the parts when servicing the equipment.

The exterior surfaces of the nozzle, where the powder exits the gun, are provided with a smooth finish and seamless transition to the gun barrel to inhibit powder from accumulating on the surfaces. This design can make it difficult to remove the nozzle from the gun body, especially if some powder is present on the surface.

### SUMMARY OF THE INVENTION

The present invention relates to a powder coating system and components thereof. The invention is directed towards improving the design of powder coating system spare parts to solve the problems described above.

A first aspect of this invention is to use “coding” to identify whether wear parts in powder coating equipment are manufactured by the original manufacturer or by a third party. The term coding is used to denote the idea of applying a color combination or other means of marking to the exterior of a wear part to indicate its manufacturer on parts where it is not practical for them to be marked with the manufacturer's trademark or name.

A second aspect of this invention includes the idea of using coding as a way of identifying the type of wear part, or a particular characteristic of the wear part.

A third aspect of the invention is that for wear components of powder coating systems which are formed from molded plastic, coding can be implemented by overmolding a base material of another color on a molded component. Different colors of color combinations can provide an indication of the manufacturer. Also, characteristics of the part, such as whether the part is a high or low flow venturi member for a powder pump, can be identified by different colors or color combinations. Thus, the term coding includes the idea of providing a visual element on the exterior of the nozzle, which can be a color combination or exterior mark, for example, to indicate the manufacturer or a characteristic of the part.

A fourth aspect is that where an overmolded material is used to code the part, if the overmolded material is elastomeric it can provide a friction fit for the wear component in, for example, a venturi pump or a spray gun, and thereby eliminate the need for O-rings or snap rings which require separate assembly steps.

A fifth aspect is that where an overmolded material is used to code the part, coding can be applied in a way to provide an indication of wear as will be explained in more detail below.

A sixth aspect, as will also be explained in more detail below, is that coding can be employed in such a way to provide easier to grip surfaces which make it easier to remove worn replacement parts from the gun and replace them with new parts.

A seventh aspect, independent of the coding aspects of the invention, is the idea of forming the replacement part as a single piece part such as a molded part to permit the incorporation of integrally formed resilient rings and/or integrally formed flanges on the exterior of the part. This eliminates the need for separate O-rings and snap rings as well as the need for machining or forming grooves into the exterior of the part to accept O-rings or snap rings, for example. This aspect of the invention applies not only to wear parts having visual coding elements but also to wear parts of a single color having no visual coding elements.

An eighth aspect, also independent of the coding aspects of the invention, is the idea of constructing wear parts of two materials, so that when the material originally in contact with the powder is worn away, the second material is exposed to indicate a certain degree of wear. This aspect of the invention also applies not only to wear parts having visual coding elements but also to wear parts of a single color having no visual coding elements.

Yet another aspect of the invention is a method of fabricating a wear part for a powder coating system. The method includes the steps of providing a base component, and overmolding a second component onto the base component. The base component and the second component can be of different colors to provide the desired coding effect.

Still another aspect of the invention is a method of fabricating a wear part for a powder coating system. The method includes the steps of providing a first layer of material having a first surface which is intended for initial contact with powder coating material and having an opposite second surface; and, providing a second layer of material in contact with the second surface of the first layer of material, the material in the second layer being different from the material in the first layer. The second layer of material becomes visible when the first layer of material wears away from contact with powder coating material.

A further aspect of the invention is a method of fabricating a wear part for a powder coating system. The method includes the steps of providing a first material; providing a second material that is relatively more resilient than the first material; and joining the first material to the second material to form the wear part so that a portion of the second material is visible on the exterior of the wear part.

Other features and advantages of the invention will be apparent from the detailed description of presently preferred embodiments which follows.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic illustration of a powder spray system including a pump shown with a venturi throat in accordance with the present invention;

FIG. 2 is an enlarged sectional view of the throat of FIG. 1, shown in a throat holder;

FIG. 3 is a further enlarged sectional view of the throat of FIG. 1;

FIG. 4 is an elevational view of the throat of FIG. 3;

FIG. 5 is a sectional view similar to FIG. 2 of a prior art venturi throat shown in the throat holder;

FIG. 6 is a schematic illustration of a powder spray gun that forms part of the system of FIG. 1, including a nozzle constructed in accordance with the present invention;

FIG. 7 is a sectional view of the nozzle of FIG. 6;

FIG. 8 is a sectional view similar to FIG. 7 of a prior art nozzle;

FIG. 9 is a sectional view of a hose connector constructed in accordance with the present invention; and

FIG. 10 is a sectional view similar to FIG. 9 of a prior art hose connector.

### DETAILED DESCRIPTION OF THE INVENTION

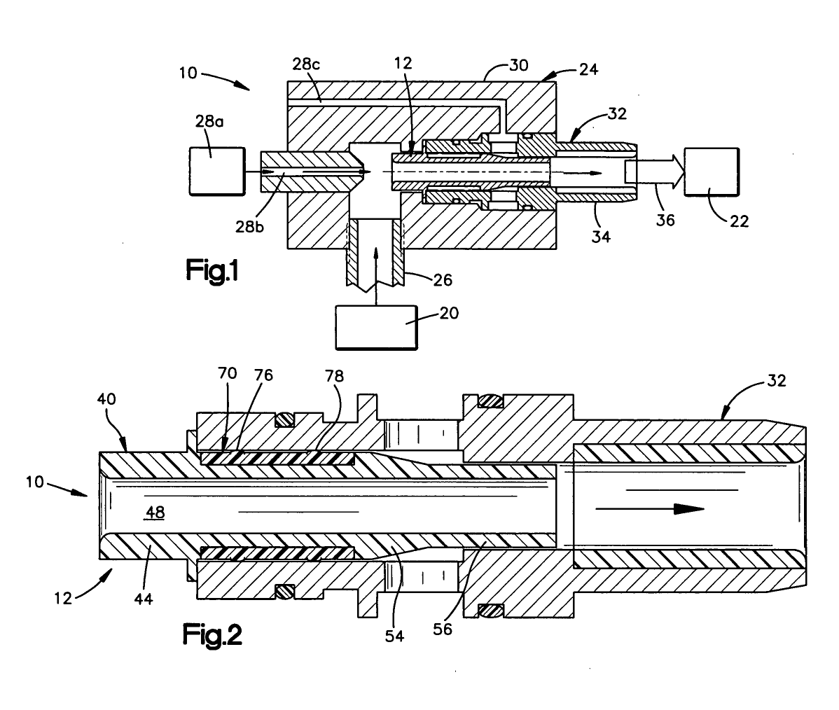

The present invention relates to powder coating systems and, in particular, to powder coating systems that include replaceable wear parts. The present invention is applicable to various coating systems and components thereof, of differing constructions. As representative of the invention, FIGS. 1-4 illustrate a powder coating system 10 including a component 12, specifically, a powder pump throat, that is constructed in accordance with the present invention.

The system 10 includes a powder supply 20 for supplying powder to a spray gun 22. The powder supply 20 provides a source of fluidized powder to a venturi pump 24 through a powder inlet 26. Supply 20 is typically a fluidized powder hopper such as shown in U.S. Pat. No. 5,018,909 which is hereby incorporated by reference in its entirety.

Air is supplied to the venturi pump 24 from a compressed air source 28a through air inlets 28b and 28c in a well-known manner. The air supplied through inlet 28b to the ejector nozzle is known as flow air in that it creates the suction which pulls powder into the pump. The air supplied through inlet 28c is known as diffuser air in that it varies the ratio of air to powder.

The venturi pump 24 includes a metal pump body 30. A throat holder 32 is removably fitted in the pump body 30. The throat holder 32 is made from metal. The throat 12 is fitted in the throat holder 32, as described below.

In a known manner, the air flowing through the throat 12 creates a venturi effect that draws the powder from the powder inlet 26 into the stream of flowing air. The air and the powder mix, within the throat 12. The air with the entrained powder exits the pump 24 through an outlet 34 and flows to the spray gun 22 through a hose shown schematically at 36. U.S. Pat. Nos. 5,518,344 and 6,428,242, which are hereby incorporated by reference in their entirety, show the pump, hose and gun connection, and gun to hose connection, respectively.

The throat 12 (FIGS. 2-4) includes a main body portion 40 and an overmolded portion 70. The main body portion 40 of the throat 12 is molded from a plastic material. The preferred material is Tivar, an ultra high molecular weight polyethylene, and is a rigid, non-elastomeric material. Tivar is a registered trademark of Poly Hi Solidur, Inc., of Neenah, Wis. Different grades of Tivar are available; the preferred grade is the highest one which is moldable.

The main body portion 40 of the throat 12 has an elongated, tubular configuration centered on an axis 42. The main body portion 40 includes a generally cylindrical wall 44 having an inner surface 46 that defines a fluid flow passage 48 centered on the axis 42. The fluid flow passage 48 extends axially through the throat 12. The inner surface 46 has a diameter that is the inner diameter of the throat 12. The inner diameter of the throat 12 is constant for the entire length of the throat, with the exception of an outwardly flared entry portion 49.

The throat wall 44 has a cylindrical outer surface 50 that defines an outer diameter of the throat 12. The outer surface 50 is located on a relatively large diameter inlet portion 52 of the throat 12. The throat wall 44 tapers inward from the outer surface 50, along a tapering portion 54, to a narrower diameter outlet portion 56 of the throat 12. The outlet portion 56 of the throat 12 has a smaller outer diameter than the remainder of the throat, but has the same inner diameter.

The inner diameter of the throat 12 controls the rate of flow of powder through the pump 24. A larger inner diameter allows greater flow, while a smaller inner diameter allows a lower flow rate. The type of throat 12 that is shown in FIG. 2 is typically available with two different throat sizes and flow rates, i.e., a standard flow and a low flow. The only difference between the parts is the inner diameter of the throat 12.

A shoulder 60 is formed on the outer surface 50 of the inlet portion 52 of the throat 12. The shoulder 60 is molded as one piece with the main body portion 40 of the throat 12. The shoulder 60 has an annular configuration extending radially outward from the outer surface 50.

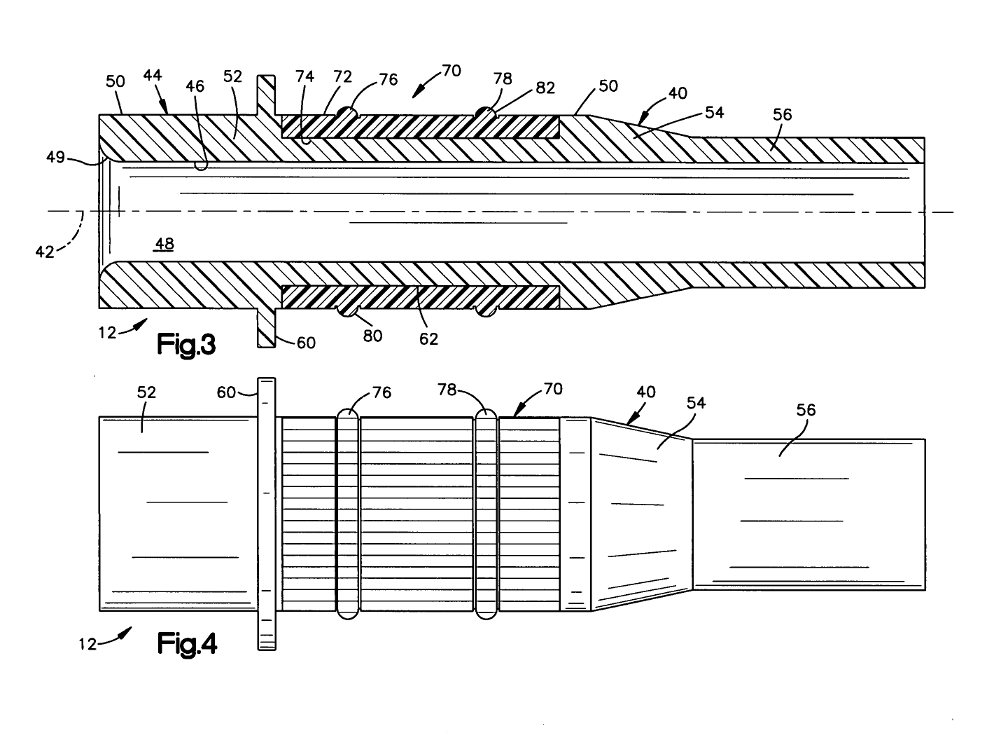

A recess or molding groove 62 (FIG. 3) is formed in the outer surface 50 of the inlet portion 52 of the throat 12, axially inward of the shoulder 60. The molding groove 62 extends axially for most of the distance between the shoulder 60 and the tapering section 54 of the main body portion 40. The depth of the molding groove 62 can be selected as desired; in the illustrated embodiment, the molding groove has a depth of about one half the wall thickness of the inlet portion 52 of the main body portion 40 of the throat 12. At the location of the molding groove 62, the wall thickness of the main body portion 40 of the throat 12 is, accordingly, reduced.

The overmolded portion 70 of the throat 12 is made from a different material than the main body portion 40. The overmolded portion 70 is made from a moldable material that when cured adheres firmly to the main body portion 40 and is elastomeric. A preferred material is Santoprene® brand thermoplastic elastomer, which is available from Advanced Elastomer Systems LP of Akron, Ohio.

The material from which the overmolded portion 70 of the throat 12 is made is preferably a different color than the color of the main body portion 40. The color difference is preferably selected so that the two portions 40 and 70 of the throat 12 can be easily distinguished from each other.

The overmolded portion 70 of the throat 12 is molded in the molding groove 62 of the main body portion 40, by a known overmolding process. The overmolded portion 70 is formed as a sleeve extending about the inlet portion 52 of the main body portion 40 of the throat 12. The overmolded portion 70 has a cylindrical outer side surface 72 and a cylindrical inner side surface 74, both extending parallel to the axis 42. The outer side surface 72 of the overmolded portion 70 preferably has substantially the same diameter as the outer side surface 50 of the main body portion 40.

The overmolded portion 70 is formed with two annular projections or rings 76 and 78. The rings 76 and 78, which are shaped to resemble the outer portions of a pair of O-rings, are formed as one piece with the remainder of the overmolded portion 70 of the throat 12. Each one of the rings 76 and 78 projects radially outward from the outer side surface 72 of the overmolded portion 70. The ring 76 has an arcuate outer surface 80. Similarly, the ring 78 has an arcuate outer surface 82.

When the throat 12 is inserted in the throat holder 32 as shown in FIG. 2, the shoulder 60 on the main body portion 40 engages the end of the throat holder. This engagement sets the limit of movement of the throat 12 into the throat holder 32, that is, in a direction to the right as viewed in FIG. 2.

The rings 76 and 78 are resilient and deform to seal between the throat 12 and the throat holder 32. The rings 76 and 78 also provide a friction fit against the throat holder 32. As a result, the throat 12 is removably held in position in the throat holder 32 by the friction fit of the overmolded portion 70, specifically, by the rings 76 and 78. The throat 12, which is a wear component of the system 10, can be removed from the throat holder 32 by pulling it out with sufficient force to overcome the friction fit of the rings 76 and 78 against the throat holder. The friction fit of the throat 12 in the throat holder 32, as provided by the rings 76 and 78, provides for easy disassembly for cleaning and replacement of the throat.

The difference in coloration between the overmolded portion 70 of the throat 12 and the main body portion 40 provides the throat with several advantages. First, it is possible to identify different throats 12 by providing them with overmolded portions 70 of different colors. For example, the overmolded portion or sleeve 70 of a low flow throat 12 can be a different color from the overmolded portion 70 of a standard flow throat 12, while the main body portions 40 remain the same color. If this is done, a quick glance at the sleeve 70 can indicate the size even though the throats 12 are physically identical except for the inner diameter. Distinguishing the throats 12 by color, in this manner, can be more accurate and more efficient than distinguishing by measurement of the inner diameter.

Coding of the throat 12 can also indicate that the wear part is manufactured by the applicant. Coding can also provide wear indication for a wear component of the system 10. Specifically, in one preferred embodiment, the throat 12 is a multi-layered structure along at least a portion of its length—in the area of the overmolded portion 70. When the throat 12 wears from contact with the powder flowing through the passage 48, the material of the main body portion 40 is eroded from inside out. When that material erodes sufficiently, the inner side surface 74 of the overmolded portion 70 becomes visible from inside the throat 12. When that occurs, it is readily apparent that the throat 12 is worn and should be replaced, because the overmolded portion 70 is a different color than the main body portion 40. The wall thickness of the main body portion 40, radially inward of the overmolded portion 70, can be selected to indicate when the throat 12 should be replaced.

Further, forming the throat 12 as described with a molded main body portion 40 and an overmolded portion 70 reduces the number of parts and the amount of labor needed to assemble the throat. To illustrate, FIG. 5 shows a prior art throat 90 as described above. The prior art throat 90 has a separate snap ring 92 and two O-rings 94. In the throat 12 of the present invention, the snap ring 92 is eliminated and replaced by the shoulder 60 that is molded as one piece with the remainder of the main body portion 40 of the throat. The O-rings 94 are eliminated and replaced by the rings 76 and 78 on the overmolded portion 70. The new one-piece design of the present invention provides significant advantages to the user or service personnel. When the throat member is replaced, the service person is not required to have on hand the O-rings and snap ring in addition to the throat member in order to replace the part. In addition, no assembly of the O-rings and snap ring to the throat member is required, which can be a somewhat awkward process for some service personnel given that these parts are small and difficult to grasp. In addition, O-rings and snap rings do break from time to time during assembly, which further complicates the servicing of the equipment if spare O-rings and snap rings are not on hand. Furthermore, in that the prior art throat 90 must accept two O-rings and a snap ring, it is normally designed as a machined part, which is typically more expensive than a molded part.

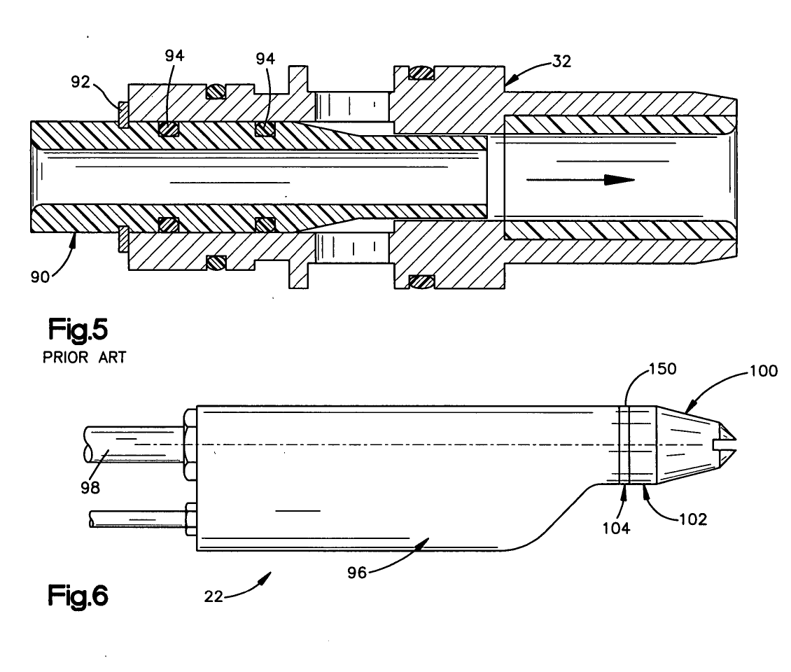

FIG. 6 is a schematic illustration of the powder spray gun 22 of the system of FIG. 1. The gun 22 includes a body 96. One or more inlet hoses 98 supply air and powder to the gun. The air and powder exit the gun 22 through a nozzle 100 that is constructed in accordance with the present invention.

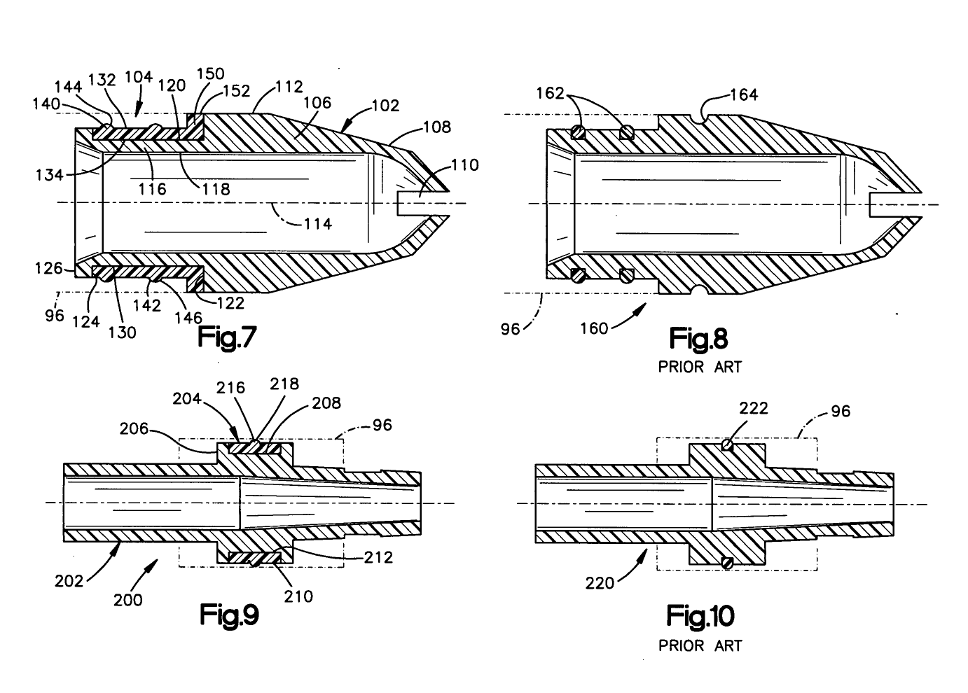

The nozzle 100 (FIG. 7) has a main body portion 102 and an overmolded portion 104. The main body portion 102 of the nozzle 100 is molded from a rigid material, which may be the same material from which the main body portion 40 of the throat 12 is made.

The main body portion 102 includes a round, tubular wall 106 that terminates in a tapering outlet end 108 with a slit 110 through which the powder coating material is sprayed. The wall 106 has a cylindrical outer surface 112, centered on an axis 114, that defines an outer diameter of the nozzle 100.

The main body portion 102 of the nozzle 100 also includes an inlet portion 116. The inlet portion 116 of the nozzle 100 is formed as a cylindrical wall having cylindrical inner and outer side surfaces 118 and 120 that extend parallel to the axis 114. The outer surface 120 is smaller in diameter than the outer surface 112 of the main body portion 102. An annular first shoulder surface 122 on the main body portion 102 extends radially between the surfaces 112 and 120. An annular second shoulder surface 124 on the main body portion 102 extends radially outward from the outer surface 120 of the inlet wall 116, at a location near the inner terminal end 126 of the nozzle 100.

As a result, a recess or molding groove 130 is formed in the nozzle 100, between the first and second shoulder surfaces 122 and 124. The molding groove 130 extends axially for most of the length of the inlet wall 116 of the main body portion 102 of the nozzle 100. The depth of the molding groove 130 can be selected as desired. In the illustrated embodiment, the molding groove has a depth about equal to the wall thickness of the inlet wall 116.

The overmolded portion 104 of the nozzle 100 is molded in the molding groove 130 of the main body portion 102, by a known overmolding process. The overmolded portion 104 is formed as a sleeve extending about the inlet wall 116 of the main body portion 102 of the nozzle 100. The overmolded portion 104 has a cylindrical outer side surface 132 and a cylindrical inner side surface 134, both extending parallel to the axis 114. The outer side surface 132 of the overmolded portion 104 has a reduced diameter as compared to the diameter of the outer side surface 112 on the main body portion 102.

The overmolded portion 104 of the nozzle 100 is made from a different material than the main body portion 102. The overmolded portion 104 is made from a moldable material that when cured adheres firmly to the main body portion 102 and is elastomeric. The overmolded portion 104 is preferably made from the same material as the overmolded portion 70 of the throat 12.

The material from which the overmolded portion 104 of the nozzle 100 is made is preferably a different color than the color of the main body portion 102. The color difference is preferably selected so that the two portions 102 and 104 of the nozzle 100 can be easily distinguished from each other.

The overmolded portion 104 is formed with two annular projections or rings 140 and 142. The rings 140 and 142, which are shaped to resemble the outer portions of a pair of O-rings, are formed as one piece with the remainder of the overmolded portion 104 of the nozzle 100. Each one of the rings 140 and 142 projects radially outward from the outer side surface of the overmolded portion 104. The ring 140 has an arcuate outer surface 144. Similarly, the ring 142 has an arcuate outer surface 146.

In addition, the overmolded portion 104 is formed with an annular gripping ring or flange 150. The ring 150 is located against the shoulder 122 on the main body portion 102 surface of the nozzle 100. The ring 150 extends radially outward from the outer side surface 132. The ring 150 has a cylindrical outer side surface 152 which has an outer diameter equal to the outer diameter on the outer surface 112 of the main body portion 102.

When the nozzle 100 is inserted in the gun body 96, the gripping ring 150 on the overmolded portion 104 of the nozzle engages the end of the gun body. This engagement sets the limit of movement of the nozzle 100 into the gun body 96, that is, in a direction to the left as viewed in FIGS. 6 and 7.

The rings 140 and 142 are resilient and deform to seal between the nozzle 100 and the gun body 96. The rings 140 and 142 provide a friction fit against the gun body 96. As a result, the nozzle 100 is held in position in the gun body 96 by the friction fit of the overmolded portion 104, specifically, by the rings 140 and 142. The nozzle 100, which is a wear component of the system 10, can be removed from the gun body 96 by pulling it out with sufficient force to overcome the friction fit of the rings 140 and 142 against the gun body. The friction fit of the nozzle 100 in the gun body 96, as provided by the rings 140 and 142, provides for easy disassembly for cleaning and replacement of the nozzle.

When the nozzle 100 is thus assembled with the gun body 96, the gripping ring 150 is located on the outside of the gun body. The outer side surface 152 of the ring 150 may therefore be manually engaged to help remove the nozzle 100 from the gun body 96. Because the gripping ring 150 is a part of the overmolded portion 104, which is made from an elastomeric material, the gripping ring provides a better gripping surface than is provided in the prior art design to aid in removal of the nozzle 100 from the gun body 96.

In addition, the nozzle 100 is a multi-layered structure along the portion of its length—adjacent the area of the overmolded portion 104. When the nozzle 100 wears from contact with the powder flowing through it, the material of the main body portion 102 is eroded from inside out. When that material erodes sufficiently, the overmolded portion 104 becomes visible from inside the nozzle 100. When that occurs, it is readily apparent that the nozzle 100 is worn and should be replaced, because the overmolded portion 104 is a different color than the main body portion 102. The wall thickness of the main body portion inlet portion 116, radially inward of the overmolded portion 104, can be selected to indicate when the nozzle 100 should be replaced.

Forming the nozzle 100 as described with a molded main body portion 102 and an overmolded portion 104 reduces the number of parts and the amount of labor needed to assemble the nozzle 160. FIG. 8 is an illustration of a prior art nozzle 160. The prior art nozzle 160 has separate O-rings 162. In the nozzle 100 of the present invention, the O-rings are eliminated and replaced by the rings 140 and 142 on the overmolded portion. The advantages of a single piece replaceable wear part as compared to a multiple piece wear part assembly are the same as those described previously with respect to the single piece venturi throat wear part. In addition, the prior art nozzle 160 is a machined plastic part since it must include two grooves for the O-rings, which is typically more expensive to fabricate than a molded part.

Note also that in addition to the grooves for the O-rings, the prior art nozzle 160 has an external groove 164, which is formed in the nozzle by a relatively costly machining process. The groove 164 is provided to aid in gripping and removal of the nozzle 160 from the gun body, because the nozzle is made from a hard, smooth material. As noted above, with the present invention, the gripping ring 150, which is part of the overmolded portion 104, replaces the groove 164 and the need to form it on the nozzle 100.

To demonstrate yet another example of how the present invention can be applied to wear parts in powder systems, FIG. 9 is a sectional view of a hose connector 200 that is constructed in accordance with the present invention. The hose connector is usable in the spray gun 22 of the system 10.

The hose connector 200 has a main body portion 202 and an overmolded portion 204. The main body portion 202 of the hose connector 200 is molded from a rigid material, which may be the same material from which the main body portion 40 of the throat 12 and the main body portion 102 of the nozzle 100 are made.

The main body portion 202 has an enlarged diameter fitting section 206 in which is formed a molding groove 208. The overmolded portion 204 of the hose connector 200 is molded in the molding groove 208 of the main body portion 202, by a known overmolding process. The overmolded portion 204 is formed as a sleeve having a cylindrical outer side surface 210 and a cylindrical inner side surface 212.

The overmolded portion 204 of the hose connector 200 is made from a different material than the main body portion 202, preferably the same elastomeric material as the overmolded portion 70 of the throat 12 and the overmolded portion 104 of the nozzle 100. The material from which the overmolded portion 204 of the hose connector 200 is made is preferably a different color than the color of the main body portion 202. The color difference is preferably selected so that the two portions 202 and 204 of the hose connector 200 can be easily distinguished from each other.

The overmolded portion 204 is formed with an annular projection or ring 216. The ring 216, which is shaped to resemble the outer portion of an O-ring, is formed as one piece with the remainder of the overmolded portion 204 of the hose connector 200. The ring 216 projects radially outward from the outer side surface 210 of the overmolded portion 204. The ring 216 has an arcuate outer surface 218.

When the hose connector 200 is inserted in the gun body 96, the ring 216 on the overmolded portion 204 of the hose connector deforms to seal between the hose connector and the gun body. The ring 216 also provides a friction fit against the gun body 96. As a result, the hose connector 200 is held in position in the gun body 96 by the friction fit of the overmolded portion 204, specifically, by the ring 216. The hose connector 200, which is a wear component of the system 10, can be removed from the gun body 96 by pulling it out with sufficient force to overcome the friction fit of the ring 216 against the gun body. The friction fit of the hose connector 200 in the gun body 96, as provided by the ring 216, provides for easy disassembly for cleaning and replacement of the hose connector.

In addition, when the hose connector 200 wears from contact with the powder flowing through it, the overmolded portion 204 becomes visible from inside the hose connector. It becomes apparent that the hose connector 200 is worn and should be replaced, because the overmolded portion 204 is a different color than the main body portion 202. The wall thickness of the main body portion 202, radially inward of the overmolded portion 204, can be selected to indicate when the hose connector 200 should be replaced.

Forming the hose connector 200 as described with a molded main body portion 202 and an overmolded portion 204 reduces the number of parts and the amount of labor needed to assemble the hose connector. FIG. 10 is an illustration of a prior art hose connector 220. The prior art hose connector 220 has a separate O-ring 222. In the hose connector 200 of the present invention, the O-ring is eliminated and replaced by the ring 216 on the overmolded portion 204. In addition, the prior art hose connector 220 is a machined plastic part, which is typically more expensive than a molded part.

It should be evident, then, that one aspect of the invention is a method of fabricating a wear part for a powder coating system. The method includes the steps of providing a base component, and overmolding a second component onto the base component. The base component and the second component can be of different colors to provide the desired coding effect. The second component may provide an elastomeric exterior portion of the wear part, specifically, one or more elastomeric exterior rings on the wear part. The second component may also provide an integral flange on the wear part.

Another aspect of the invention is a method of fabricating a wear part for a powder coating system. The method includes the steps of providing a first layer of material having a first surface which is intended for initial contact with powder coating material and having an opposite second surface; and, providing a second layer of material in contact with the second surface of the first layer of material, the material in the second layer being different from the material in the first layer. The second layer of material becomes visible when the first layer of material wears away from contact with powder coating material.

In this method, the first and second layers of material may be of different colors, for the coding purposes set forth above and to improve the indication of the wearing away of the first layer of material. The second layer of material may be overmolded on the first layer of material, and may provide an elastomeric exterior portion of the wear part, specifically, one or more elastomeric exterior rings on the wear part. The second layer of material may also provide an integral flange on the wear part.

A further aspect of the invention is a method of fabricating a wear part for a powder coating system. The method includes the steps of providing a first material; providing a second material that is relatively more resilient than the first material; and joining the first material to the second material to form the wear part so that a portion of the second material is visible on the exterior of the wear part. In this method, the step of providing a second layer of material may include providing one or more elastomeric exterior rings on the wear part. Also in this method, the step of providing a first material may include providing a first layer of material having a first surface which is intended for initial contact with powder coating material and having an opposite second surface, and the joining step may include providing a second layer of the second material that is in contact with the second surface of the first layer of material, the second layer of material becoming visible when the first layer of material wears away from contact with powder coating material. Further, the step of providing a first material may include providing a first material of a first color, and the step of providing a second material may include providing a second material of a second color different from the first color.

Having described the various aspects of this invention with relation to three preferred embodiments, it will be appreciated by those skilled in the art that this invention improves upon spare part design in many ways such as using a visual coding element to make it possible to identify the manufacture of the spare part without marking the spare part with the manufacturer's trademark or name. In addition, or alternatively, the visual coding element can be used to indicate a characteristic of the part. Further, parts can be formed as single piece assemblies reducing fabrication costs while increasing the ease with which spare parts can be replaced in the field.

From the above description of various preferred embodiment of the invention those skilled in the art will appreciate that the teachings of the invention can be applied to other wear components of a powder coating system and that those described in the preferred embodiments are only examples used to demonstrate the teachings of the invention. Moreover, while coding of power coating system wear parts is accomplished in the presently preferred embodiment through the use of the overmolding process, it will be apparent to those skilled in the art that methods other than overmolding could be used to code wear parts and achieve some or all of the various advantages of the invention. For example, instead of using the overmolding process, coding could be accomplished in the following ways: shrink wrapping a color band or stripe on the exterior of the part which may or may not have a machined or otherwise formed recess to accept the color band; applying a strip, band or other marking by means of an adhesive to the exterior of the part; applying a stripe or other marking to the exterior of the part using laser marking, painting or another coating process; or machining or otherwise forming a ring or other receiving area on the exterior of the part and installing a snap ring or other element in the recess. Other techniques could be used as well to provide a coded visual element on the exterior of the part. In addition to the coding aspects of the invention, the idea of forming the replacement part as a single piece part such as a molded part permits the incorporation of integrally formed resilient rings and/or integrally formed flanges on the exterior of the part to take the place of O-rings and snap rings, while at the same time eliminating the need for machining or forming grooves in the exterior of the part to receive the O-rings or snap rings. Another aspect of the invention is to construct the wear part of two materials so that when the material originally in contact with the powder is worn away, the second material is exposed to indicate a certain degree of wear. These latter two aspects of the invention apply not only to wear parts having visual coding elements but also to wear parts of a single color having no visual coding elements. Accordingly, while various modifications to the invention will be apparent to those skills in the art, such modifications are intended to be included within the scope of the appended claims

Having described the invention, I claim:

1. A wear part for a powder coating system, said wear part being molded from two different materials.

2. A wear part as set forth in claim 1 wherein said wear part is a nozzle or a throat or a hose connector.

3. A wear part as set forth in claim 1 having a main body portion that is molded from a first material and a secondary portion that is molded from a second material different from said first material.

4. A wear part as set forth in claim 3 wherein said secondary portion is elastomeric and is shaped to provide a friction fit for said wear part in a coating system device in which said wear part can be installed.

5. A wear part as set forth in claim 3 wherein said secondary portion is shaped as a pair of O-rings.

6. A wear part as set forth in claim 3 wherein said secondary portion is a different color from said main body portion of said wear part.

7. A wear part as set forth in claim 6 wherein said secondary portion is elastomeric and is shaped to provide a friction fit for said wear part in a coating system device in which said wear part can be installed.

8. A wear part as set forth in claim 3 wherein said secondary portion includes a shoulder for setting the longitudinal position of said wear part in a coating system device in which said wear part can be installed.

9. A wear part as set forth in claim 3 wherein said wear part is a throat and said secondary portion comprises an elastomeric material that provides a friction fit for said wear part in a throat holder, said main body portion of said throat forming a shoulder for setting the longitudinal position of said throat in the throat holder.

10. A wear part as set forth in claim 9 wherein said secondary portion of said wear part is a different color from said main body portion of said wear part.

11. A wear part as set forth in claim 3 wherein said wear part is a nozzle for fitting into a gun body and said secondary portion comprises an elastomeric material having a first section disposed inside said gun body that provides a friction fit for said wear part in the gun body and a second section on the exterior of said gun body that provides a gripping surface for said nozzle.

12. A wear part as set forth in claim 11 wherein said secondary portion of said nozzle is a different color from said main body portion of said nozzle.

13. A wear part as set forth in claim 3 wherein said wear part is a hose connector and said secondary portion comprises an elastomeric material that provides a friction fit for said hose connector in a gun body.

14. A wear part for a powder coating system, said wear part having a first wall portion partially defining a flow channel for powder, said first wall portion including first and second layers of material.

15. The wear part of claim 14 wherein said first and second layers are of different colors.

16. A wear part as set forth in claim 14 wherein said first layer of material continues past said second layer of material to form a second wall portion, said second wall portion being made only from said first layer of material, said first layer of material in said first wall portion being thinner than said first layer of material in said second wall portion.

17. A wear part as set forth in claim 15 wherein said second layer of material overlies said first layer of material in said first wall portion of said wear part, whereby sufficient wear of said first layer of material in said first wall portion renders said second layer of material visible from said flow channel.

18. A wear part as set forth in claim 15 wherein said second layer of material comprises an elastomeric material that provides a friction fit for said wear part in a coating system device in which said wear part can be installed.

19. A molded wear part for a powder coating system, said wear part being molded from at least one plastic material, said wear part having a portion that is elastomeric and is shaped to provide a friction fit for said wear part in a coating system device in which said wear part can be installed.

20. A wear part as set forth in claim 19 having a main body portion that is molded from a first material and a secondary portion that is overmolded on said main body portion from a second material different from said first material.

21. A wear part as set forth in claim 19 wherein one of said main body portion and said overmolded portion includes a shoulder for setting the longitudinal position of said wear part in a coating system device in which said wear part can be installed.

22. A nozzle for a powder coating material spray gun, said nozzle having a relatively more resilient portion of the surface on the exterior of the nozzle form a gripping surface for removal of said nozzle from the gun.

23. A nozzle as set forth in claim 22 wherein said relatively more resilient portion of the surface on the exterior of the nozzle is a molded portion of said nozzle which includes a part that is partially received in a body of the gun and that is elastomeric and that is shaped to provide a friction fit of said nozzle in the gun body.

24. A nozzle as set forth in claim 22 wherein said molded portion is an overmolded portion on a main nozzle body.

25. A nozzle as set forth in claim 22 wherein said overmolded portion is colored differently from the main nozzle body.

26. A wear component of a powder coating system, the component being contacted by the powder coating material and worn away by the powder coating material as the powder coating material flows through the system, the component having an exterior surface wherein said exterior surface includes a coded visual element.

27. The component of claim 26 wherein the coded visual element provides an indication of the manufacturer of the component.

28. The component of claim 26 wherein the coded visual element provides an indication of a characteristic of the component.

29. The component of claim 26 wherein the coded visual element comprises constructing the component with a first portion of a first color and a second portion of a second color.

30. The component of claim 26 wherein the component is a spray nozzle of a powder coating gun.

31. The component of claim 29 wherein at least one of the first portion and the second portion is molded.

32. The component of claim 31 wherein the first portion is a molded component and the second portion is an over molded component.

33. A component for a pump for transporting powder coating material, the component being contacted by the powder coating material as the powder coating material flows through the pump, the component having an exterior surface wherein said exterior surface includes a coded visual element.

34. The component of claim 33 wherein the coded visual element provides an indication of the manufacturer of the component.

35. The component of claim 33 wherein the coded visual element provides an indication of a characteristic of the component.

36. The component of claim 33 wherein the coded visual element comprises constructing the complement with a first portion of a first color and a second portion of a second color.

37. The component of claim 33 wherein the component is a venturi throat for a powder pump.

38. The component of claim 36 wherein at least one of the first portion and the second portion is molded.

39. The component of claim 36 wherein the first portion is a molded component and the second portion is an over molded component.

40. A wear part for a powder coating system, said wear part being constructed as a single piece component having on its exterior an integrally formed resilient ring.

41. They wear part of claim 40 further comprising an integrally formed flange.

42. The wear part of claim 40 further comprising a visual coding element formed on the exterior of said part.

43. The wear part of claim 40 wherein said visual coding element provides an indication of the identity of the manufacturer of said part.

44. The wear part of claim 40 wherein said visual coding element provides information relating to a characteristic of the part.

45. The wear part of claim 40 wherein said part comprises an overmolded part constructed from two different materials.

46. A method of fabricating a wear part for a powder coating system, comprising the steps of:
providing a base component; and
overmolding a second component onto the base component.

47. A method as set forth in claim 46 wherein said step of providing a base component comprises providing a base component of a first color, and said step of overmolding a second component onto the base component comprises overmolding a second component of a second color different from the first color.

48. A method as set forth in claim 47 wherein said step of overmolding a second component onto the base component comprises providing an elastomeric exterior portion of the wear part.

49. A method as set forth in claim 48 wherein said step of overmolding a second component onto the base component comprises providing one or more elastomeric exterior rings on the wear part.

50. A method as set forth in claim 46 wherein said step of overmolding a second component onto the base component comprises providing an integral flange on the wear part.

51. A method as set forth in claim 46 wherein said step of overmolding a second component onto the base component comprises providing an elastomeric exterior portion of the wear part.

52. A method as set forth in claim 51 wherein said step of overmolding a second component onto the base component comprises providing one or more elastomeric exterior rings on the wear part and providing an integral flange on the wear part.

53. A method of fabricating a wear part for a powder coating system, comprising the steps of:
providing a first layer of material having a first surface which is intended for initial contact with powder coating material and having an opposite second surface; and
providing a second layer of material in contact with the second surface of the first layer of material, the material in the second layer being different from the material in the first layer;
the second layer of material becoming visible when the first layer of material wears away from contact with powder coating material.

54. A method as set forth in claim 53 wherein said step of providing a first layer of material comprises providing a first layer of material of a first color, and said step of providing a second layer of material comprises providing a second layer of material of a second color different from the first color.

55. A method as set forth in claim 53 wherein said step of providing a second layer of material comprises overmolding the second layer of material on the first layer of material.

56. A method as set forth in claim 53 wherein said step of providing a second layer of material comprises providing an elastomeric exterior portion of the wear part.

57. A method as set forth in claim 56 wherein said step of providing a second layer of material comprises providing one or more elastomeric exterior rings on the wear part.

58. A method as set forth in claim 56 wherein said step of providing a second layer of material comprises providing an integral flange on the wear part.

59. A method of fabricating a wear part for a powder coating system, comprising the steps of:
providing a first material;
providing a second material that is relatively more resilient than the first material; and
joining the first material to the second material to form the wear part so that a portion of the second material is visible on the exterior of the wear part.

60. A method as set forth in claim 59 wherein said step of providing a second layer of material comprises providing one or more elastomeric exterior rings on the wear part.

61. A method as set forth in claim 59 wherein said step of providing a first material comprises providing a first layer of material having a first surface which is intended for initial contact with powder coating material and having an opposite second surface, and said joining step comprises providing a second layer of the second material that is in contact with the second surface of the first layer of material, the second layer of material becoming visible when the first layer of material wears away from contact with powder coating material.

62. A method as set forth in claim 59 wherein said step of providing a first material comprises providing a first material of a first color, and said step of providing a second material comprises providing a second material of a second color different from the first color.
